(19) United States
(12) Patent Application Publication
(10) Pub. No.: US 2025/0070195 A1
(43) Pub. Date: Feb. 27, 2025

(54) VEHICLE WITH A FUEL CELL SYSTEM, AND METHOD FOR THE OPERATION THEREOF

(71) Applicant: ZF CV Systems Global GmbH, Bern (CH)

(72) Inventors: Jens Hoffmeister, Hannover (DE); Arne Reiners, Hannover (DE); Janik Ricke, Uetze (DE)

(21) Appl. No.: 18/945,181

(22) Filed: Nov. 12, 2024

Related U.S. Application Data
(63) Continuation of application No. PCT/EP2023/056885, filed on Mar. 17, 2023.

(30) Foreign Application Priority Data
May 12, 2022 (DE) 10 2022 111 917.3

(51) Int. Cl. H01M 8/04111; H01M 8/0438; H01M 8/04746; H01M 8/0662

(52) U.S. Cl. CPC H01M 8/04111; H01M 8/04425; H01M 8/04753; H01M 8/04776; H01M 8/0687; H01M 2250/20

(57) ABSTRACT

A vehicle, in particular a utility vehicle, includes a fuel cell system which has a first compressor unit for supplying a fuel cell with compressed air and a second compressor unit for supplying a compressed air system of the vehicle with compressed air. The first compressor unit has an output which is connected via a branch line to an input of the second compressor unit in a fluid-conducting manner, in such a way that a first part flow of the compressed air which is output by the first compressor unit is fed to the fuel cell, and a second part flow of the compressed air which is output by the first compressor unit is fed to the second compressor unit.

### CROSS-REFERENCE TO RELATED APPLICATIONS

This application is a continuation application of international patent application PCT/EP2023/056885, filed Mar. 17, 2023, designating the United States and claiming priority from German application 10 2022 111 917.3, filed May 12, 2022, and the entire content of both applications is incorporated herein by reference.

### TECHNICAL FIELD

The present disclosure relates to a vehicle, in particular a utility vehicle, with a fuel cell system which has a first compressor unit for supplying a fuel cell with compressed air, and a second compressor unit for supplying a compressed air system of the vehicle with compressed air. Vehicles of the type denoted above are well known. According to the disclosure, a compressed air system is understood to be the compressed air architecture of the vehicle which supplies compressed air via one or more line circuits to all pneumatic loads of the vehicle which are relevant for safety and also not relevant for safety, for example a pneumatic brake system and/or a pneumatic chassis of the vehicle. On account of the particular requirements of the controller of the fuel cell, fuel cell systems as a rule have a dedicated compressor unit for supplying compressed air to the fuel cell.

### BACKGROUND

While the “conventional” compressors for supplying compressed air to the compressed air systems are as a rule configured to generate high system pressures which can lie in the range above 10 bar, in part above 12 bar or considerably above this, and frequently use piston compressors with rotational speeds in the four digit range with at the same time a low throughput in order to achieve these pressures, the compressor units of the fuel cell systems usually have turbo compressors which deliver very much higher throughputs at comparatively low system pressures in the order of magnitude of 5 bar or less. To this end, the compressor units of fuel cell systems are usually operated in the high five digit rotational speed range.

Both the supply of compressed air for compressed air systems of the vehicle and the supply of compressed air to the fuel cell systems fundamentally function satisfactorily. Compressor units are in the meantime electrical loads, just like other components in the vehicle. In the course of mobility change, the necessary energy for operating the vehicle is increasingly provided in electrical form in the vehicle and is stored in corresponding energy stores. The requirement for energy efficiency also relates to the electrical loads, and these include the compressor units. The installation space requirement for the compressor units is a structural limitation.

### SUMMARY

It is an object of the disclosure to meet the above-described challenge to the maximum possible extent. In particular, the disclosure is based on an object of achieving an increase in efficiency in the case of a vehicle of the type denoted at the outset.

The disclosure achieves the object on which it is based in the case of a vehicle of the type denoted at the outset by the first compressor unit having an output which is connected via a branch line to an input of the second compressor unit in a fluid-conducting manner, in such a way that a first part flow of the compressed air which is output by the first compressor unit is fed to the fuel cell, and a second part flow of the compressed air which is output by the first compressor unit is fed to the second compressor unit.

The disclosure is based on the finding that, although the second compressor unit which is responsible for the compressed air system of the vehicle beyond the fuel cell has to generate comparatively high pressures, it requires only very low throughput quantities, in the order of magnitude of <1000 l/min at approximately 12.5 bar at the output of the second compressor unit, in particular <500 l/min at approximately 12.5 bar at the output of the second compressor unit. This is where the disclosure comes into play, by connecting the output of the first compressor unit via the branch line to the input of the second compressor unit. Hereby, the first compressor unit becomes the pre-compressor for the second compressor unit. As a result, the second compressor unit can perform the compression work in a manner which already proceeds from a higher pressure level, which can lead to a significantly lowered power requirement in relation to the second compressor unit, which power requirement is greater the higher the pressure at the output of the first compressor unit. As a result, the second compressor unit can be of considerably smaller dimensions overall, which produces both cost advantages and a reduction in size of the installation space. Since the required additional throughput is low relative to the throughput which is requested in any case by the fuel cell, the first compressor unit does not have to be of greater dimensions, or at any rate does not have to be of significantly greater dimensions. In addition to the considerably lower power consumption, further efficiency-increasing factors are therefore also added which result from the first compressor unit of the fuel cell system and the second compressor unit of the compressed air system being connected in series. The cost advantages relate, in particular, to the cost-intensive components of the compressor units such as, for example, the electric machines and electronic power system.

In various embodiments, the second compressor unit is connected on the output side to a compressed air store in a fluid-conducting manner, and is configured to additionally compress the compressed air which is fed to it from the first compressor unit and to feed it to the compressed air store. Depending on how high the pressure level is on the output side of the second compressor unit, it can even already be advantageous for the compressed air to be conducted through the second compressor unit without additional compression work until the pressure level of the output side of the first compressor unit is reached at least once on the output side, in particular the compressed air store, and only then to begin with the additional compression work.

In various embodiments, the first compressor unit has an air filter which is arranged upstream of the branch line. The first compressor unit further can preferably have a compressor, and the air filter is arranged upstream of the compressor and is configured to filter air which is fed to the first compressor unit before entry into the compressor. Depending on the application, multiple-stage compressors (which therefore have more than only one compressor stage) are certainly used in the case of the compressor units for the fuel cell systems. In order to comprehend the disclosure, however, the explanation on the basis of only a single compressor is sufficient. It should be understood that the disclosure also applies in the case of compressor units which have more than one compressor, wherein it fundamentally has an advantageous effect for the air filter to be positioned as far upstream as possible, in order to protect the compressor unit against dirt ingress.

In various embodiments, the fuel cell system, the first compressor unit, is configured to be operated with a variable throughput, and the vehicle has a control unit which is configured to generate an air request signal for controlling the throughput of the first compressor unit. In view of the fact that the additionally required throughput in the first compressor unit for feeding the branch line is low in comparison with the throughput which is required in any case for the fuel cell, namely lies in the single digit percentage range as a rule, as viewed relative to the throughput for the fuel cell, control of the rotational speed, in particular, is sufficient in preferred embodiments, in order to control the throughput for the case of the presence of an air request signal.

If, according to the disclosure, the throughput of the compressor units is mentioned, this is to be understood to mean that the throughput can be characterized by the mass flow which flows through the compressor unit, or else by the volumetric flow and pressure which flows through the compressor unit, preferably in each case on the output side.

The air request signal in the context of the disclosure is representative for the additional delivery requirement needed by the second part flow. The second compressor unit is preferably configured to be operated at a constant operating point, and it can therefore be predicted with satisfactory precision how much throughput, that is, how much additional delivery requirement, is necessary on the part of the first compressor unit if the second compressor unit has to start operating in order to supply the compressed air system of the vehicle with additional compressed air. Input and output pressures of the second compressor unit are known, and the throughput through the second compressor unit can be selected in such a way that the latter can be operated at a favorable operating point.

All of these variables can be determined in advance in the preliminary tests and in the course of the configuration of the system, with the result that, in the simplest case, the air request signal can be a digital signal with the states “0” (no air request signal is present) and “1” (air request signal is present). The air request signal can be transmitted as a predefined current or voltage signal, or as an encoded signal, for example via a bus system of the vehicle, such as for instance a CAN bus.

In various embodiments, the first compressor unit is connected in a signal-conducting manner to the control unit, and is configured to adapt, in particular to increase, the throughput delivered by it in a manner which is dependent on the air request signal. If, in other words, the air request signal is present at the first compressor unit, the first compressor unit adjusts its throughput in such a way that both the fuel cell can be supplied with the first part flow and the second compressor unit can be supplied with the second part flow.

The first compressor unit can preferably be configured, in a first operating mode, to deliver a first throughput which, in the case of an inactive second compressor unit, is fed exclusively to the fuel cell, and, in a second operating mode, to deliver a second throughput which is higher than the first throughput and from which, in the case of an active second compressor unit, the first part flow for the fuel cell and the second part flow for the second compressor unit are formed. In other words, the compressor unit is configured to transfer from the first operating mode into the second operating mode as soon as the air request signal is present.

The first compressor unit can preferably be configured to compress the air to the same output pressure in the second operating mode as in the first operating mode. The pressure preferably lies in a range below 5 bar, such as for instance from 2 bar to 4 bar. In this way, the supply of compressed air to the second compressor unit does not compromise the operation of the fuel cell system. At the same time, the adaptation of the operation of the first compressor unit to a higher rotational speed level which can be determined in advance computationally or experimentally is sufficient for a control operation of this type in the simplest case.

In various embodiments, the vehicle has a pressure sensor for detecting the air pressure in the compressed air store, and the control unit is connected in a signal-conducting manner to the pressure sensor and is configured to generate the air request signal as soon as the air pressure in the compressed air store reaches or undershoots a predefined switch-on pressure. The switch-on pressure preferably lies in a range of 10 bar or less. As an alternative or in addition, the compressed air store has a setpoint pressure value which is also called an operating pressure, for example in the range of 12.5 bar or more. The control unit preferably generates the air request signal as soon as the air pressure in the compressed air store lies 10% or more below the setpoint pressure value.

In various embodiments, the control unit is configured to actuate the second compressor unit to compress the compressed air which is fed to it, after the air request signal has been generated. In a first preferred variant, the control unit is configured to actuate the second compressor unit after expiry of a predefined (first) delay period, wherein the delay period lies, in particular, in a range of 0.5-3.5 seconds. In a second variant, the control unit is preferably configured as an alternative or in addition to actuate the second compressor unit after the first compressor unit has transmitted a confirmation signal to the control unit stating that the throughput has been adapted. In a third preferred variant, the vehicle has a sensor for detecting the throughput of the first compressor unit, for example a mass flow sensor or a volumetric flow sensor (then preferably in conjunction with a pressure sensor), and the sensor is connected in a signal-conducting manner to the control unit or the second compressor unit, and is configured to transmit a representative signal for the throughput to the respective unit. These control operations ensure that the second compressor unit does not begin to early with the compression work, which might entail a compressed air undersupply of the fuel cell in unfavorable cases. The upstream actuation of the first compressor prevents the second compressor from running with an unfavorable degree of efficiency (or not at all) on account of the insufficient input pressure.

In various embodiments, the control unit is configured to set the second compressor unit into the active state for as long as the air request signal is present.

In various embodiments, the control unit is configured to generate the air request signal until the air pressure in the compressed air store reaches or exceeds a predefined switch-off pressure. The switch-off pressure preferably lies in a range of 12.0 bar or above. As an alternative or in addition, the switch-on pressure lies in a range from 10% to 15% below the switch-off pressure.

In various embodiments, the first compressor unit is configured to adapt, in particular to lower, the throughput after a predefined (second) delay period from the cessation of the air request signal. The delay period preferably lies in a range from 0.5 seconds to 3.5 seconds. This continued delivery of the higher throughput also serves to avoid an undersupply.

In various embodiments, the fuel cell system has a control unit, for example a fuel cell controller, which is configured to actuate the first compressor unit and which is connected in a signal-conducting manner to the control unit. The connection between the control unit of the fuel cell system and the control unit of the compressed air system might be ensured, for example, via a CAN bus or a similar bus connection. In alternative preferred embodiments, the control unit can also be integrated in hardware or software terms into the fuel cell controller.

In various embodiments, the vehicle has an air preparation module which is connected downstream of the second compressor unit, wherein the control unit is preferably integrated into the air preparation module. It is also the case here that the control unit can also be configured as a dedicated independent control unit as an alternative. As an alternative, for example, the control unit can also be assigned to the second compressor unit, or can also be integrated in hardware or software terms into its controller.

The above-described air preparation module (also called an APU and, in particular, an eAPU (Air Processing Unit)) preferably includes an air dryer and/or a valve arrangement such as, for example, a multiple-circuit protection valve, and/or a pressure sensor. If the air preparation module includes the control unit, the control unit is preferably configured, furthermore, to regulate the pressure in the flow process on the output side at the second compressor unit, and therefore the operation of the compressor, and to generate the air request signal as described above. Depending on the presence of further logic units in the vehicle, it can also be appropriate for the control unit to be integrated into other logic units (not mentioned by name herein).

In the above embodiments, a series connection of the first compressor unit and the second compressor unit has been described which always also assumed the operation of the first compressor unit for pre-compression for the operation of the second compressor unit. During operation of the vehicle, situations can occur, in which the first compressor unit is not active, for example in the case of defects, or if the fuel cell is shut down in the case of relatively long descents being traveled along or in the case of downtimes. If operation of the second compressor unit nevertheless becomes necessary in situations of this type, in an embodiment, the vehicle has a bypass line which bypasses the first compressor unit and opens upstream of the second compressor unit. In this way, the input for the air to be compressed which otherwise bypasses the first compressor unit is connected directly to the second compressor unit, and the second compressor unit can be operated, even if at a lower input pressure than would be ideal for its operation, with bypassing of the first compressor unit.

In embodiments, in which the first compressor unit has at least one compressor, that is, one compressor stage, and in which the air filter stream is arranged upstream of the compressor, the bypass line preferably extends from an outflow between the air filter and the compressor toward the branch line. As a result, even for the case where the second compressor unit has to be operated without the first compressor unit, only one air filter is necessary which can be assigned to the central input for the compressor units and performs its function in an undiminished manner, even if the first compressor unit is not active.

The disclosure has been described above on the basis of a first aspect with reference to a vehicle. In a further aspect, the disclosure relates, furthermore, to a method for operating a vehicle, in particular a utility vehicle. The disclosure achieves the object designated at the outset in the case of a method of this type, in which the method includes the steps:
supplying a fuel cell with compressed air via a first compressor unit, and
supplying a compressed air system of the vehicle with compressed air via a second compressor unit, wherein a first part flow of the compressed air which is output by the first compressor unit is fed to the fuel cell, and a second part flow of the compressed air which is output by the first compressor unit is fed to the second compressor unit.

With regard to the second aspect, the disclosure utilizes the same advantages and considerations as the vehicle in accordance with the first aspect. Preferred embodiments of the vehicle are at the same time preferred embodiments of the method, and vice versa.

In various embodiments, the method is developed by way of one, a plurality of or all of the following features:
the compressed air which is fed to the second compressor unit by the first compressor unit is additionally compressed and fed to the compressed air store; and/or the air which is fed to the first compressor unit is filtered upstream of the branch line, in particular upstream of the first compressor unit; and/or
the first compressor unit is operated with a variable throughput; an air request signal is generated to control the throughput of the first compressor unit, preferably as soon as an air pressure in the compressed air store reaches or undershoots a predefined switch-on pressure, further preferably until a predefined switch-off pressure is reached or exceeded; and/or
the throughput which is delivered by the first compressor unit is adapted, in particular increased, in a manner which is dependent on the air request signal;
in a first operating mode, a first throughput is delivered which, in the case of an inactive second compressor unit, is fed exclusively to the fuel cell, and, in a second operating mode, a second throughput is delivered which is higher than the first throughput and from which, in the case of an active second compressor unit, the first part flow for the fuel cell and the second part flow for the second compressor unit are formed, wherein the air is preferably compressed in the second operating mode to the same output pressure as in the first operating mode and/or the same throughput is delivered as the second part flow as in the first operating mode as a total throughput; and/or
the second compressor unit is actuated after the air request signal has been generated; and/or
the throughput which is delivered by the first compressor unit is adapted, in particular lowered, after a predefined delay period from cessation of the air request signal; and/or
the first compressor unit is bypassed via a bypass line which opens upstream of the second compressor unit.

### BRIEF DESCRIPTION OF DRAWINGS

The invention will now be described with reference to the drawings wherein:

FIG. 1 shows a diagrammatic illustration of a vehicle, in accordance with an embodiment; and,

FIG. 2 shows a method sequence for the operation of the vehicle according to FIG. 1.

### DETAILED DESCRIPTION

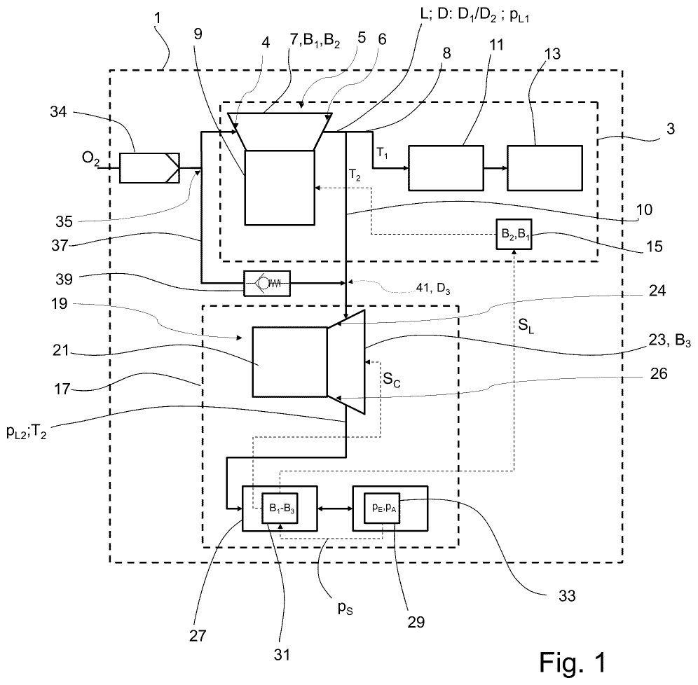

FIG. 1 shows a diagrammatic illustration of a vehicle 1 which can be, for example, a utility vehicle. The vehicle 1 has a fuel cell system 3 which includes a compressor unit 5. The compressor unit 5 has at least one (first) compressor 7 which is driven by an electric machine 9. The compressor 7 can be, for example, a radial compressor, axial compressor or scroll compressor. The compressor unit 5 is configured to intake air containing oxygen O₂ at an input 4, to compress it to an output pressure p_{L1}, and to output it at an output 6 with a throughput D which is controlled according to the operation of the compressor unit 5. Compressed air L is thus fed on the cathode side to a fuel cell 13 via a main line 8. An air humidifier 11 is optionally arranged in the main line 8.

The fuel cell system 3 has a control unit 15 which can be constructed as one or more structural units and can be, for example, the fuel cell controller, and/or a compressor control unit. The control unit 15 can be configured as a dedicated control unit, or can be integrated in hardware or software terms into the fuel cell 13 or the compressor unit 5.

In addition to the fuel cell system 3, the vehicle 1 has, furthermore, a compressed air system 17. The compressed air system 17 serves to supply the compressed air L to pneumatic loads of the vehicle 1 which are relevant to safety or are not relevant to safety, and has a dedicated compressor unit 19. The compressor unit 5 of the fuel cell system 3 is therefore a first compressor unit, and the compressor unit 19 of the compressed air system 17 is a separate dedicated second compressor unit.

The second compressor unit 19 has an electric machine 21 which is configured to drive a (second) compressor 23 of the second compressor unit 19, but might also be, as an alternative, for example an internal combustion engine connected via a clutch. The compressor 23 can be, for example, a piston or scroll compressor.

The second compressor unit 19 can be configured, for example, as a piston compressor, while the first compressor unit 5 of the fuel cell system is preferably configured as a turbo compressor.

The second compressor unit 19 of the compressed air system 17 is connected via an input 24 and a branch line 10 in a fluid-conducting manner to the output 6 of the first compressor unit 5 of the fuel cell system 3. The second compressor unit 19 is configured to further compress the compressed air L, fed to it by the branch line 10, from the output pressure p_{L1} of the first compressor unit 5 to a second output pressure p_{L2}>p_{L1}, and to output this further compressed part flow T₂ via an output 26, while compressed air L at p_{L1} is still delivered as first part flow T₁ to the fuel cell 13 via the main line 8. The total throughput D consists of T₁ and T₂.

The compressed air system 17 has an air preparation module 27 (also called an APU (Air Processing Unit) or eAPU (electronic Air Processing Unit)) which is connected downstream of the second compressor unit 19. The air preparation module 27 is configured to condition, for example to dry, the air which is compressed by the second compressor unit 19, and to feed it indirectly or directly to a compressed air store 29 which is connected in a fluid-conducting manner to the air preparation module 27.

Furthermore, the compressed air system 17 has a control unit 31 which can be integrated, for example, in software or hardware terms into the air preparation module 27, or can be an independent control unit. The control unit 31 of the compressed air system 17 is configured to actuate the second compressor unit 19 for operation via a compressor control signal S_{C}.

The control unit 31 is connected in a signal-conducting manner to a pressure sensor 33, wherein the pressure sensor 33 is configured to detect an air pressure p_{S}=p_{L2} of the compressed air store 29. The pressure sensor 33 is preferably assigned structurally to the compressed air store 29, but can also be arranged in the fluid line between the air preparation module 27 and the compressed air store 29, or can be integrated into the air preparation module 27.

The control unit 31 is configured to transmit an air request signal S_{L} to the fuel cell system 3 as soon as the pressure p_{S} in the compressed air store 29 reaches or undershoots a predefined switch-on pressure p_{E}. The switch-on pressure p_{E} preferably lies 10-15% or more below the actual operating pressure of the compressed air store, as described in detail in the general part.

The control unit 31 is configured to output the air request signal S_{L} and the compressor control signal S_{C} as long as is necessary, in order to supply the compressed air store 29 sufficiently with compressed air L. In particular, the control unit 31 is configured to switch off the outputting of the air request signal S_{L} and the compressor control signal S_{C} when the pressure p_{S} of the compressed air store 29 has reached or has exceeded a switch-off pressure p_{A} which preferably lies 10-15% above p_{E}.

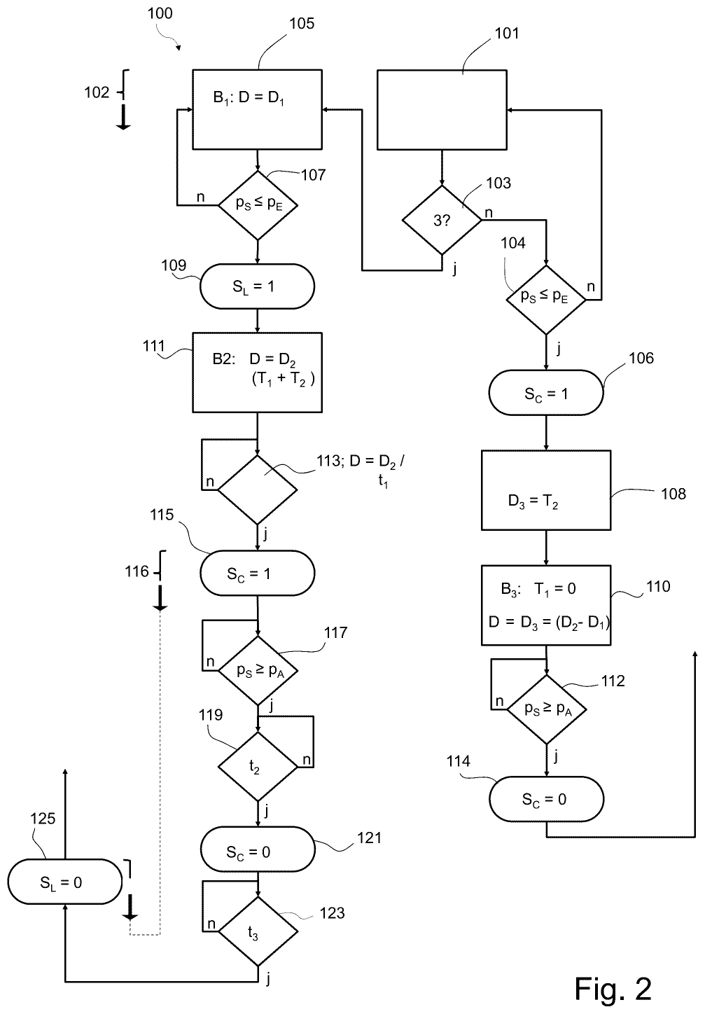

The generating and switching off of the signals S_{L} and S_{C} can take place at the same time, but can also take place with a time delay, as will be explained in greater detail with reference to FIG. 2.

The fuel cell system 3 is configured to switch over the operation of the first compressor unit 5 between a first operating mode B₁ and a second operating mode B₂ in a manner which is dependent on receipt of the air request signal S_{L}. In the first operating mode B₁, the first compressor unit 5 is configured to deliver and to compress a first throughput D₁ which is sufficient for operation of the fuel cell 13, in particular for operation with excess oxygen.

The first compressor unit 5 is configured to deliver, in the second operating mode B₂, a second throughput D₂ which is so much greater than the first throughput D₁ that the second part flow T₂ is additionally delivered without the output pressure p_{L1} dropping.

The second operating mode B₂ is as a rule activated when the control unit 31 of the compressed air system 17 activates the second compressor unit 19 via outputting of the compressor control signal S_{C}, in order to increase the pressure in the compressed air store 29. In the case of an activated second compressor unit 19, the throughput D₂ which is present at the output 6 of the first compressor unit 5 is split into the first part flow T₁ and the second part flow T₂, wherein the first part flow T₁ preferably has a throughput which is precisely as high as D₁ in the first operating mode B₁. The additional throughput (D₂-D₁) flows as the second part flow T₂ through the branch line 10 into the first compressor unit 19.

The vehicle 1 has an air filter 34 which is configured to purify the air O₂, sucked in by the fuel cell system 3, in a generally known way before entry into the first compressor unit 5. Connecting the first compressor unit of the fuel cell system to the second compressor unit 19 of the compressed air system 17 in series results here in a further specific advantage of the disclosure. Merely a single air filter 34 is required for contamination-free operation of the two compressor units 5, 19. The air filter 34 can be assigned to the fuel cell system 3, but it can also be connected upstream of the fuel cell system 3 as a dedicated structural unit, as indicated here in FIG. 1. The air filter 34 is active even during bypassing operation via the bypass line 37, and is then used for direct filtering of the flow of air O₂ fed exclusively to the second compressor unit 19 bypassing the first compressor unit 5.

The above-described application which is considered to be the main application presupposes simultaneous operation of the first compressor unit 5 and the second compressor unit 19 over at least certain time portions in the second operating mode B₂. There can be operating situations, however, in which the first compressor unit 5 cannot be operated, but nevertheless compressed air is required to increase the compressed air store 29. For these situations, the vehicle 1 has a bypass line 37 which extends from an outflow 35 upstream of the compressor 7 as far as a connector piece 41 in the branch line 10. A check element 39 prevents an undesired return flow of compressed air Lin the direction of the outflow 35.

FIG. 2 illustrates a method sequence for the operation of the vehicle 1 according to FIG. 1.

A plurality of method steps will be described and depicted sequentially in the following description. During actual operation of the vehicle 1, these steps do not necessarily have to be carried out, however, in this temporal sequence, but rather can also at least partially take place at the same time. The following sequential depiction serves for improved understanding.

In a starting step 101 of the method 100, the vehicle 1 is operated for travel. As soon as a decision is made in a first decision step 103 that operation of the fuel cell system 3 is necessary, the fuel cell 13 is driven in the first operating mode B₁ in the next method step 105 in order to deliver a first throughput D₁ of compressed air L. As long as the delivery of compressed air L is carried out via the first compressor unit 5, a supply of a fuel cell with compressed air is carried out in step 102 via a first compressor unit.

If the vehicle 1 requires compressed air from the compressed air system 17 for its operation, this compressed air is provided from the compressed air store 29. As soon as it is detected in step 107 that the pressure p_{S} reaches or undershoots the switch-on pressure p_{E}, the control unit 31 generates in step 109 the air request signal S_{L}, as a consequence of which, in step 111, the first compressor unit 5 is caused to adjust the second throughput D₂ in the second operating mode B₂. As soon as the required throughput D₂ for the two part flows T₁, T₂ is reached, and/or after a predefined first delay period t₁ has passed, which is checked in step 113, the second compressor unit 19 is also actuated via the compressor control signal S_{C} in step 115 in order to start operation.

As long as the delivery of the second part flow T₂ takes place by way of the second compressor unit 19, that is, if a method step 116 of supplying the compressed air system 17 of the vehicle 1 with compressed air L is carried out via the second compressor unit 19, the first part flow T₁ of the compressed air L which is output by the first compressor unit 5 is fed to the fuel cell 13, and the second part flow T₂ of the compressed air L which is output by the first compressor unit 5 is fed to the second compressor unit 19.

The air request signal S_{L} is still present during this. Simultaneous operation of the two compressor units 5, 19 is continued for as long as the pressure p_{S} will have to be raised in the compressed air store 29.

As soon as it is determined in step 117 that the pressure p_{S} reaches or exceeds the switch-off pressure p_{A}, the operation of the second compressor unit is stopped, preferably after a second delay duration t₂ is maintained in step 119, via switching off of the compressor control signal S_{C} in step 121.

After a third delay duration t₃ has preferably been reached in step 123, the air request signal S_{L} can also be switched off in step 125, and a return can be made to the operation only of the first compressor unit 5 according to step 105 or no compressor unit according to step 101.

In the following text, an alternative operating situation which can occur is to be discussed. If, during operation according to step 101 of the vehicle 1, it is determined in the case of the check according to step 103 that operation of the fuel cell system 3 is not required, but it is determined in the following step 104 that the pressure p_{S} in the compressed air store 29 undershoots the switch-on pressure p_{E}, the compressor control signal S_{C} is transmitted by the control unit 31 to the second compressor unit 19 without actuating the first compressor unit 5 beforehand, see step 106.

As a consequence, in a step 108, the first compressor unit 5 of the fuel cell system 3 is bypassed via the bypass line 37. In step 110, the second compressor unit 19 of the compressed air system 17 compresses, in a third operating mode B₃, the air O₂ which is fed in on the input side at ambient pressure (or the input pressure upstream of the fuel cell system 3). A third throughput D₃ is preferably delivered which can correspond, for example, to the above-described part flow T₂=(D₂−D₁).

As soon as it is determined in step 112 that the pressure pₛ in the compressed air store 29 is greater than or equal to the switch-off pressure p_{A}, the compressor control signal S_{C} can be switched off in step 114, and a return can be made to the operation of the vehicle as according to step 101.

It is understood that the foregoing description is that of the preferred embodiments of the invention and that various changes and modifications may be made thereto without departing from the spirit and scope of the invention as defined in the appended claims.

### LIST OF DESIGNATIONS (PART OF THE DESCRIPTION)

1 Vehicle
3 Fuel cell system
4 Input, fuel cell system
5 First compressor unit, fuel cell system
6 Output, fuel cell system
7 (First) compressor, fuel cell system
8 Main line
9 Electric machine, fuel cell system
10 Branch line
11 Air humidifier
13 Fuel cell
15 Control unit, fuel cell system
17 Compressed air system
19 Second compressor unit, compressed air system
21 Electric machine, compressed air system
23 (Second) compressor, compressed air system
24 Input, second compressor unit
29 Compressed air store, compressed air system
31 Control unit, compressed air system
34 Air filter
35 Outflow to bypass line
37 Bypass line
41 Connector piece of bypass line
100 Method
101 Starting step
102 Supplying the fuel cell
103 Deciding, fuel cell operation
104 Detecting pₛ≤p_{E}
105 Start, operating mode B₁
106 Beginning, actuating second compressor unit
107 Detecting pₛ≤p_{E}
108 Bypassing first compressor unit
109 Generating air request signal S_{L}
110 Start, operating mode B₃
111 Start, operating mode B₂
112 Detecting pₛ≥p_{A}
113 Detecting D=D₂ and/or t₁
114 End, operating mode B₃
115 Beginning, actuating second compressor unit
116 Supplying the compressed air system
117 Detecting pₛ≥p_{A}
119 Detecting t₂
121 End, actuating second compressor unit, end B₂
123 Detecting t₃
125 End, generating air request signal S_{L}
B₁, B₂, B₃ Operating modes
D, D₁, D₂, D₃ Throughput
L Compressed air
O₂ Air
t₁, t₂, t₃ Delay period
T₁, T₂ Part flow
S_{L} Air delivery signal
S_{C} Control signal
p_{L1} Output pressure, first compressor unit
p_{L2} Output pressure, second compressor unit
pₛ Air pressure, compressed air store
p_{E} Switch-on pressure
p_{A} Switch-off pressure

1. A vehicle comprising:
a fuel cell system having a first compressor unit for supplying a fuel cell with compressed air and a second compressor unit for supplying a compressed air system of the vehicle with compressed air;
said second compressor unit having an input; and,
said first compressor unit having an output connected via a branch line to said input of said second compressor unit in a fluid-conducting manner such that a first part flow of the compressed air which is output by said first compressor unit is fed to said fuel cell and a second part flow of the compressed air which is output by said first compressor unit is fed to said second compressor unit.

2. The vehicle of claim 1, wherein said second compressor unit is connected on an output side to a compressed air store in a fluid-conducting manner and is configured to additionally compress the compressed air which is fed to said second compressor unit from said first compressor unit and to feed it to said compressed air store.

3. The vehicle of claim 1, wherein said first compressor unit has an air filter arranged upstream of said branch line.

4. The vehicle of claim 3, wherein said first compressor unit has a compressor; and, said air filter is arranged upstream of said compressor and is configured to filter air which is fed to said first compressor unit before entry into said compressor.

5. The vehicle of claim 1 further comprising:
a control unit;
said first compressor unit being configured to be operated with a variable throughput; and,
said control unit being configured to generate an air request signal for controlling said variable throughput of said first compressor unit.

6. The vehicle of claim 5, wherein said fuel cell system is connected in a signal-conducting manner to said control unit and is configured to adapt said throughput delivered by said fuel cell system in a manner dependent upon said air request signal.

7. The vehicle of claim 5, wherein said fuel cell system is connected in a signal-conducting manner to said control unit and is configured to increase said throughput delivered by said fuel cell system in a manner dependent upon said air request signal.

8. The vehicle of claim 5, wherein said first compressor unit is connected in a signal-conducting manner to said control unit and is configured to adapt said throughput delivered by said first compressor unit in a manner dependent upon said air request signal.

9. The vehicle of claim 6, wherein said first compressor unit is configured, in a first operating mode, to deliver a first throughput which, in a case of said second compressor unit being inactive, is fed exclusively to said fuel cell, and, in a second operating mode, to deliver a second throughput which is higher than said first throughput and from which, in a case of said second compressor unit being active, said first part flow for said fuel cell and said second part flow for said second compressor unit are formed.

10. The vehicle of claim 9, wherein said first compressor unit is configured to compress the air to a same output pressure in said second operating mode as in said first operating mode.

11. The vehicle of claim 5 further comprising:
a pressure sensor for detecting air pressure in a compressed air store; and,
said control unit being connected in a signal-conducting manner to said pressure sensor and being configured to generate said air request signal as soon as the air pressure in said compressed air store reaches or undershoots a predefined switch-on pressure.

12. The vehicle of claim 5, wherein said control unit is configured to actuate said second compressor unit to compress the compressed air fed to said second compressor unit after said air request signal has been generated.

13. The vehicle of claim 5, wherein said control unit is configured to actuate said second compressor unit to compress the compressed air fed to said second compressor unit after a predefined delay period after said air request signal has been generated.

14. The vehicle of claim 5, wherein said control unit is configured to set said second compressor unit into an active state for as long as said air request signal is present.

15. The vehicle of claim 11, wherein said control unit is configured to generate the air request signal until the air pressure in said compressed air store reaches or exceeds the predefined switch-off pressure.

16. The vehicle of claim 5, wherein said fuel cell system is configured to adapt the variable throughput after a predefined delay period from a cessation of the air request signal.

17. The vehicle of claim 5, wherein said first compressor unit is configured to adapt said variable throughput after a predefined delay period from a cessation of said air request signal.

18. The vehicle of claim 5, wherein said fuel cell system is configured to lower the throughput after a predefined delay period from a cessation of the air request signal.

19. The vehicle of claim 5, wherein said control unit is of said compressed air system; and, said fuel cell system has a fuel cell system control unit configured to actuate said first compressor unit and which is connected in a signal-conducting manner to said control unit.

20. The vehicle of claim 5 further comprising an air preparation module connected downstream of said second compressor unit.

21. The vehicle of claim 20 wherein said control unit is integrated into said air preparation module.

22. The vehicle of claim 1 further comprising a bypass line which bypasses said first compressor unit and opens upstream of said second compressor unit.

23. The vehicle of claim 22, wherein said first compressor unit has at least one compressor; an air filter is arranged upstream of said at least one compressor; and, said bypass line extends from an outflow between said air filter and said at least one compressor to said branch line.

24. The vehicle of claim 1, wherein the vehicle is a utility vehicle.

25. A method for operating a vehicle comprising:
supplying a fuel cell with compressed air via a first compressor unit; and,
supplying a compressed air system of the vehicle with compressed air via a second compressor unit, wherein a first part flow of the compressed air which is output by the first compressor unit is fed to the fuel cell and a second part flow of the compressed air which is output by the first compressor unit is fed to the second compressor unit.

26. The method of claim 25, wherein the vehicle is a utility vehicle.
